(19) United States
(12) Patent Application Publication
(10) Pub. No.: US 2013/0002567 A1
(43) Pub. Date: Jan. 3, 2013

(54) Method and System of Implementing Multi-Touch Panel Gestures in Computer Applications Without Multi-Touch Panel Functions

(76) Inventors: Ricky Lee, Long Beach, CA (US); George Yang, Cypress, CA (US)

(21) Appl. No.: 13/174,150

(22) Filed: Jun. 30, 2011

(51) Int. Cl. G06F 3/041

(52) U.S. Cl. 345/173

(57) ABSTRACT

A method and system allows the use of multi-touch panel gestures for PC games and applications where it is not natively supported by the games or applications. Each game or application can have its own gestures and key mappings with the use of multiple profiles available to the user of the game or application. By establishing a profile a user remaps multi-touch panel gestures that the game or application does not natively support to mouse clicks or keyboard strokes that the game or application does support. A gesture parser listens for individual touch gestures of the user. Once the system recognizes a touch gesture it matches the gesture with the established game profile, and then it sends the gesture in remapped form to the game or application, where the touch gesture is recognized and executed as a mouse click or keystroke associated with a computer OS or a computer game.

### FIELD OF THE INVENTION

This invention relates to the field of multi-touch panels for computers and to computer games. More specifically, the invention is a method and system of implementing multi-touch panel computer functions in computer programs with limited or no multi-touch panel function capability, i.e., in which the computer program does not natively support multi-touch panel functions. In the preferred embodiment, the invention is a software advancement of touch interface technology in personal computers that is used in computer gaming, although it has practical uses in other computer functions and applications.

### BACKGROUND OF THE INVENTION

Commercial competition in computer gaming has constantly driven the need to make the user's gaming experience faster, more detailed, and more real. Because current games consume so much programming and storage, often ten or more gigabytes, the software development of a completely new game can take a much longer time than does the hardware on which the game is played. Such complexity has limited areas in which new generations of an existing game can include software improvements capable of remaining current with the hardware improvements. In gaming, chorded keyboards are typically used to improve and expand the player's control. These keyboards, much like a court stenographer's, permit the user to press multiple keys simultaneously. This capability increases the user's speed while also increasing the number of functions he can execute. In a non-gaming context, Ctrl-Alt-Delete has long existed as a Windows® multi-key function. Gaming keyboards and mice have improved on traditional Windows®-based keyboards. Nevertheless, each gaming mouse or keyboard comes with its own particular driver and application software, and each game comes with its own prescribed keystrokes, some of which differ or are unique from game to game. In other words, a keystroke (or simultaneous multiple keystrokes) programmed into a hypothetical Game 1 cause a different motion on the screen than does the same keystroke as it is programmed into a hypothetical Game 2.

Other gaming input devices include joysticks, steering wheels, and joypads, also called gamepads or control pads. These devices are usually more specialized than a basic mouse and keyboard combination, and they often have movements that are specific to certain types of games. These input devices also can have buttons or keys for which certain movements can correspond to mouse clicks and keystrokes. Two leading vendors of gaming mice and keyboards are Razer (www.razerzone.com) and SteelSeries (www.steelseries.com)

The prevalence of Windows®-based PC's, from the 1980s through the present, has resulted in the vast majority of computer games being developed for Windows® operating systems. Many of the most successful computer games appeared before the commercial introduction of the touch screen and tablet computers. The majority of tablet computers currently function with Apple or Google operating systems (or “OS”) designed to function with a multi-touch panel. Microsoft Windows® 7 is a relatively new OS that natively supports multi-touch functions in addition to mouse clicks and keyboard strokes, but because of current game designs the user's interaction with the computer must invariably be through a mouse and a keyboard. Some QWERTY keyboards designed for gaming include extra buttons on which the user can establish macro functions. Non-QWERTY keyboards have also been designed just for gaming, and gaming mice have been designed with as many as 17 programmable buttons to actuate multi-keystroke functions. Both QWERTY and non-QWERTY keyboards and the associated computer games permit the user to choose the functions of the buttons, which are then mapped to functions associated with a typical QWERTY keyboard that includes the additional keys that now appear on standard computer keyboards, such as Ctrl, Alt, Delete, Page Up, Page Down, F1, F2, etc. For example, in a combat game a soldier can be programmed to move forward, backward, left, or right simply by using the arrows on a traditional keyboard. Additional keys may control the speed at which the soldier moves, whether he jumps or ducks, or whether he strafes his enemies with an automatic rifle. Holding down two or more keys, such as the Ctrl and Delete keys can, for example, rotate the camera view in one direction. Alternatively, a mouse right-click and hold could permit the user to move the screen view in a different manner. Many games have a zoom in-and-out feature mapped to the mouse's scroll wheel. On a multi-touch panel this conforms to the two-finger pinch-in and pinch-out that controls the zoom function.

Because computer game developers have almost exclusively used Microsoft operating systems, and because only recently have multi-touch panels achieved commercial prominence, mouse clicks, keystrokes, and macros remain the only method for controlling a game as it appears on the screen. Microsoft recently unveiled Windows® 8, which is specifically designed to function on multi-touch panels such as tablets, without a peripheral keyboard. This change, together with the growth of non-Windows® multi-touch screens, should eventually spur game modifications and new games that are developed for multi-touch panels rather than peripheral mice and keyboards. In the meantime, screen control on a typical PC requires mouse clicks and keystrokes.

Recently iBUYPOWER (“iBP”) introduced a gaming laptop with a touch screen, i.e., a multi-touch panel. Most PC games, however, remain programmed to respond to keystrokes and mouse clicks. Because more and more multi-touch panel devices are appearing on the market, whether as PCs, laptops, tablets, or even smartphones, and because the game developers lag in offering games designed specifically to respond to multi-touch screen touches, a need has arisen to make current Windows®-based games responsive to touch screen gestures, even though the games are designed to respond to keystrokes and mouse clicks.

### SUMMARY OF THE INVENTION

The present invention solves the problem of linking gestures on a multi-touch panel with Windows®-based mouse and keyboard controlled actions that are programmed into a game, an application, or an operating system such as Windows® itself. The invention is known as Multi-touch Advanced Gaming Interface and Control, or MAGIC.

In one embodiment of the invention a method includes the steps of entering a multi-touch gesture on a touch screen; analyzing the nature of the multi-touch gesture; determining whether the analyzed multi-touch gesture corresponds to one of a list of non-multi-touch gestures in an application (e.g., a game) profile; and, sending a message to at least one of the computer application and the operating system to create an event on the touch screen by executing the non-multi-touch gesture that corresponds to the multi-touch gesture on the touch screen.

Another embodiment is a system that includes a touch screen responsive to multi-touch gestures; electronic media containing an operating system and a computer application, wherein at least one of the computer application and the operating system are programmed to create non-multi-touch gestures on the viewing screen; means for receiving touch gestures from the touch screen and analyzing the gestures; a profile of user-selectable viewing screen controls including at least one of a tap, a drag, a zoom, a rotate, and a two-finger tap, wherein the operating system is programmed to cause the viewing screen to display events caused by the controls; means, operably connected to the profile and the operating system, to cause the viewing screen to display the events.

Yet another embodiment includes a computer readable medium with programming adapted to communicate, directly or indirectly, with the electronic game and with an operating system on which the electronic game is running; means, on computer readable medium, for receiving signals representing a touch gesture on the touch screen; means, on computer readable medium, for converting touch gesture signals from the touch screen to mouse and keystroke signals adapted to create an event on a viewing screen; a user-selectable game profile, displayed on a viewing screen and stored on a computer readable medium, for entering into the application a game choice and a user's choices for the correspondence between touch screen gestures and preprogrammed mouse and keystroke signals; and, means for transmitting a gesture signal to at least one of the game and the operating system for generating a game move that appears on the viewing screen.

### BRIEF DESCRIPTION OF THE DRAWINGS

The objects and advantages of the invention will become apparent to and appreciated by those of skill in the art from the following detailed description of the invention, including the preferred embodiment, in conjunction with the accompanying drawings of which:

FIG. 1A is a representation of a MAGIC screen that includes a menu and customization options.

FIG. 1B is a different MAGIC screen than FIG. 1A that includes different customization options.

FIG. 2 is a high level flow chart that summarizes how MAGIC operates.

FIG. 3 is a more detailed flow chart of how touch gestures are converted to keystrokes and checked against the MAGIC profile for a particular game.

FIGS. 4a and 4b should preferably be viewed together as one figure and represent a combination of flow diagrams involving the initialization and game use of MAGIC as it is incorporated into an operating system and a game.

### DETAILED DESCRIPTION OF THE ILLUSTRATIVE EMBODIMENTS

MAGIC was made available at www.ibuypower.com to the public via download. While the initial purpose was to test MAGIC in a gaming environment on the iBP touch screen laptop and to obtain comments from interested garners, customer feedback and the number of downloads indicated that the application operated successfully in a non-gaming environment. For example, MAGIC has worked with Google Earth and the Chrome Internet browser. For consistency and ease of understanding the invention will be referred to as MAGIC and its operation will be described in the context of a Windows® gaming environment, such as one found on an iBUYPOWER Battalion 101 laptop with a touch screen. The Battalion 101 laptops can be seen at wwwibuypower.com/IbpPaes/Notebook/aspx. For MAGIC to operate it must first be installed on or operably connected to a Windows® computer with a multi-touch panel or touch screen. At least one computer game must also be installed or connected to the computer, although MAGIC is designed to accommodate numerous games on the same computer. The iBP laptop webpage identifies popular games such as StarCraft 2, Modern Warfare 2, Battlefield Bad Company 2, World of Warcraft, Call of Duty: Black Ops, and Crysis 2. Prior to using MAGIC the computer user must first create a profile.

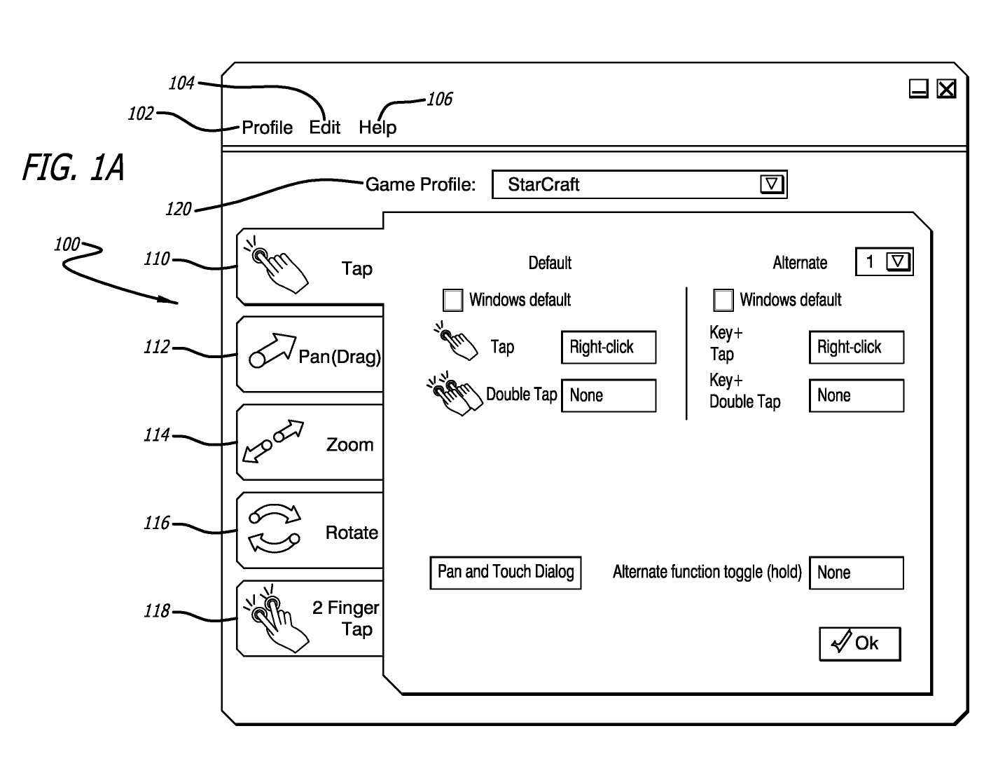

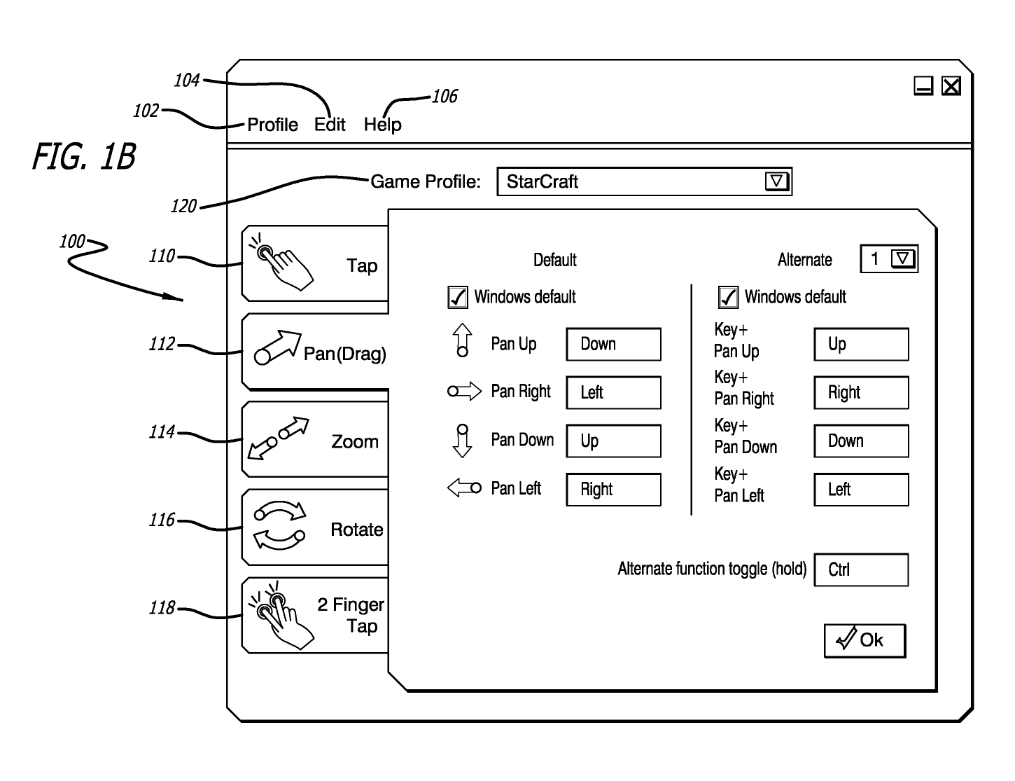

FIG. 1A is a representation of a MAGIC screen 100 with a menu and customization options. MAGIC gesture recognition is automatically enabled by default when a game is started, and it is disabled when the game is closed. The user also has the option of disabling MAGIC completely, so that the game reverts to an operation controlled by a keyboard and mouse. The menu includes Profile, Edit, and Help functions 102, 104, 106 respectively. The user taps Profile 102 to produce a pull-down menu of options (not shown) such as New Profile, Edit Profile, Import Profile, Export Profile, Manage Profile, and Exit. FIGS. 1A and 1B depict an existing Game Profile 120, which indicates that a user has already entered a game profile for StarCraft.

Selecting the New Profile option under Profile 102 in the menu creates a traditional Windows® dialog box (not shown) in which the user names the New Profile, presumably with the name of a specific game profile he wishes to establish, like Starcraft or Call of Duty: Black Ops. A Windows® browse button in the dialog box permits the user to select the game file associated with the Profile Name. As currently designed, the user must locate and select the game's executable file. In Windows® the file suffix is typically identified by “.exe”, so, for example, the user would identify the file as “Starcraft.exe”. The implementation and operation of the other menu options under Profile 102 are understood by game developers and users.

MAGIC does permit the user to specify keyboard input rather than multi-touch gesture recognition. The customization options on the MAGIC screen 100 include multi-touch panel gestures Tap 110, Pan or Drag 112, Zoom 114, Rotate 116, and 2-Finger Tap 118, which correspond to standard movements programmed into the Windows® OS or the game itself. Most games provide options that permit the user to control certain aspects of these movements, such as the speed of the rotation instruction. MAGIC allows the user to select or to disable one or more touch gestures in favor of gestures generated by a keyboard or mouse by the Windows® OS. The games gestures or screen control designations that do not natively respond to a touch screen are called non-multi-touch gestures. The user also has the option of selecting the default mouse or keyboard gesture as programmed in the Windows® OS or of reprogramming the gesture to occur when a specific, non-default mouse or keyboard stroke is entered. FIGS. 1A and 1B demonstrate different user options. FIG. 1A depicts a user-selected single tap gesture to be the equivalent of a right-click on a mouse. The user has chosen not to enable a double-tap gesture, as indicated by the word “None” inside the boxes identified as Double Tap. In FIG. 1B two different selections appear for the Pan or Drag option. In the left center of the screen 100, under the heading “Default,” the panning up gesture on the touch screen is equivalent to striking the down arrow on a keyboard, which moves the screen down so the user can see “up,” i.e., what is above the current screen display. This is the Windows® default action. The other three touch gestures—Pan Right, Pan Left, Pan Down—also result in the opposite movement of the screen. On the right side of the screen, under the heading “Alternate,” a different configuration of the pan gestures is configured. In the alternate configuration, striking the up arrow moves the screen up, not down. As indicated by the “Ctrl” button in the bottom right corner of FIG. 1B, the alternate screen movements are effectuated by toggling the “Ctrl” key on the keyboard while using the Pan touch gesture on the touch screen.

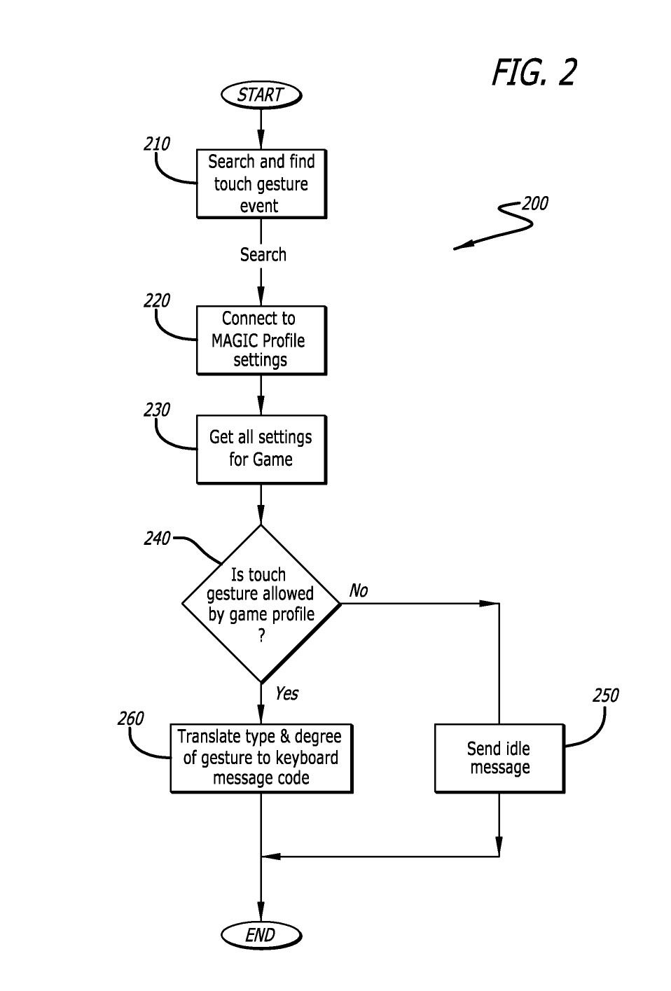

FIG. 2 is a basic, high level flow chart that generally summarizes how MAGIC operates. A Gesture Parser 200 continually listens, i.e., checks or tests, for touch gesture events 210. Once a touch gesture has been identified. MAGIC matches the gesture to the instruction that has been mapped in the game profile. See steps 220, 230. MAGIC then, in step 240, checks and determines whether the touch gesture is permitted by the game profile. If it is, then in step 260 MAGIC translates the type and degree of gesture and sends the instruction to the Windows® OS or to the game. Alternatively, step 250 would send an idle message, meaning that the game or program should not take any action. Strategy-based games in particular use non-action screen instructions, such as when an army should remain stationary rather than move. Based on the game profile, an instruction in step 260 can be the MAGIC gesture default action or it can be a mouse or keyboard instruction established by the user. It should be noted that the Gesture Parser as described in FIG. 2 presumes that the profiled game uses one or more of the established MAGIC conversions from a touch gesture to a mouse or keystroke. At startup MAGIC could also be programmed to check to see if MAGIC has been disabled. If the user has disabled MAGIC completely for the duration of a particular game, then MAGIC could allow the game to completely bypass the MAGIC process and revert to converting touch gestures only for mouse and keyboard events specified by the computer's OS or by the game.

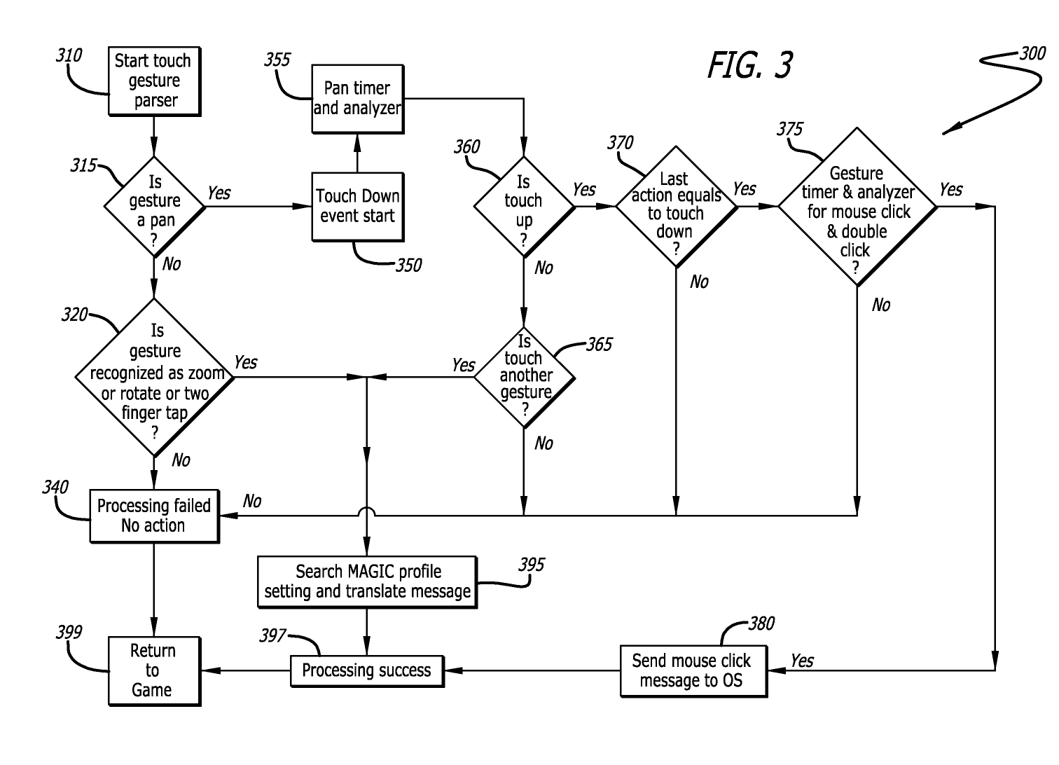

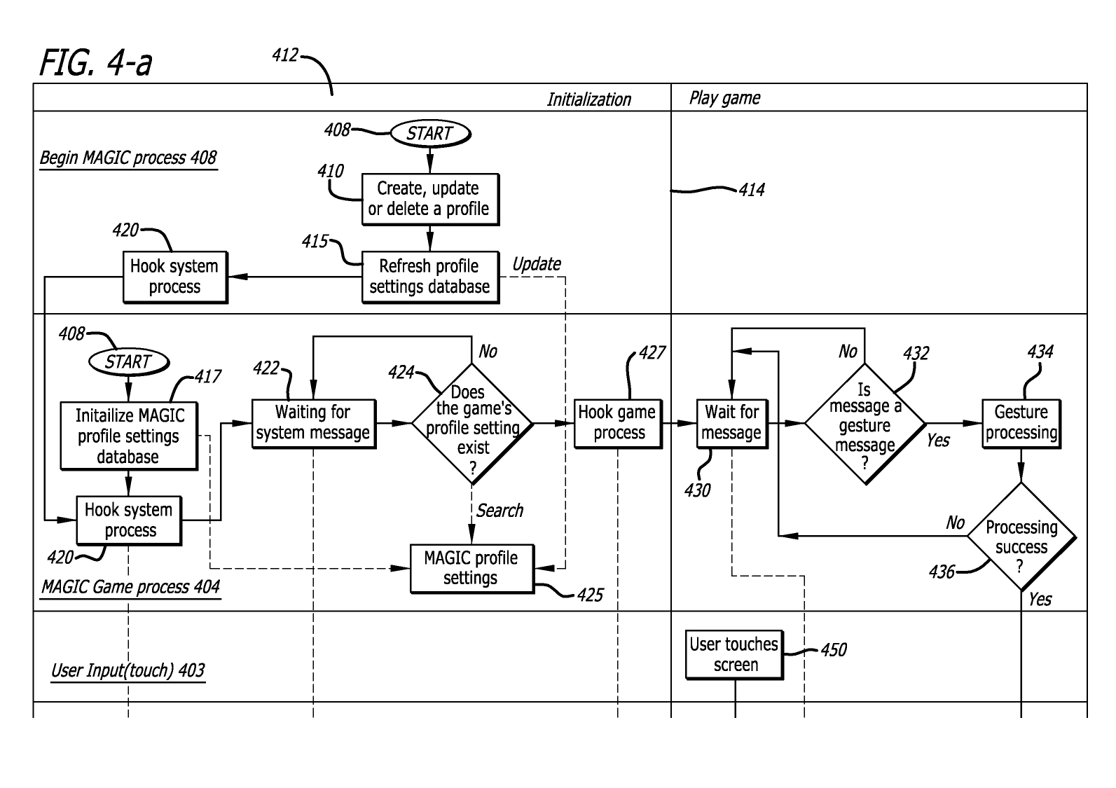

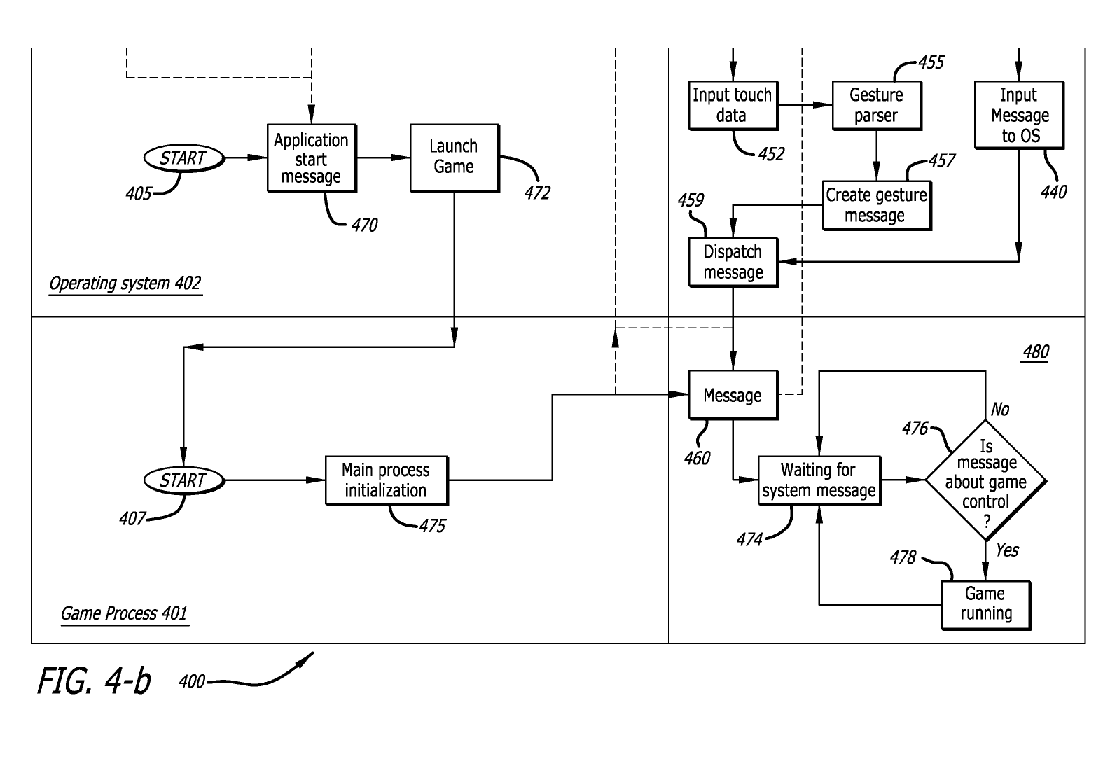

FIG. 3 is a more detailed flow chart of how touch gestures are converted to keystrokes and checked against the MAGIC profile for the particular game. The flow chart's method 300 is part of the overall system depicted in FIGS. 4a and 4b. The conversion begins with touch gesture parser 310 that receives message—also referred to simply as information—that a touch gesture has occurred. Decision block 315 asks whether the gesture is a pan or another type of motion. If the answer is yes, the nature of the pan is analyzed by touch down event start 350, touch up decision block 360, and the intervening Pan timer and analyzer 355. If the last gesture is a touch down as asked by step 370, then the gesture must be further analyzed 375 as either a tap or double tap that is the equivalent to single or double mouse clicks respectively. If the gesture is a mouse click the information is sent to the Windows® OS 380, after which the parser returns to the game 399.

If the gesture is not recognized as some form of pan or tap, the system checks to see if the gesture is recognized as a zoom, rotate, or two-finger tap 320. If the gesture is not a zoom, rotate, or two-finger tap then the system recognizes that the parsing has failed 340, so no action is taken and the system returns to the game 399 and awaits another gesture. If the gesture is one of those three actions, then it is recognized as a move and sent to the MAGIC profile 395 to determine the comparable keyboard setting, the gesture is actuated in the game, the analysis is recognized as a success 397, and the system returns to the game 399 to search and wait for more gesture messages.

FIGS. 4a and 4b should be understood as a single FIGURE. The two parts represent a combination of subsidiary flow diagrams involving the initialization and game-use of MAGIC as it is incorporated into or connected to the operating system and the game. The complete diagram is divided into right and left sides and five vertical rows. As indicated in header 412, the left side of the diagram contains the “Initialization Process” and the right side contains the “Game Process.” For the length of combined FIGS. 4a and 4b these two parts are divided by line 414. The five rows indicate the major processes that occur sequentially or at times almost simultaneously, during the course of a game. They are the Game Process 401, the operating system or OS 402, the user multi-touch panel interface 403, the MAGIC Game Process 404, and the MAGIC startup 408. When the operating system starts 405 it looks for an application start message 470 which launches the game 472 and game process 407. When game process begins, it moves into an initialization phase 475 that includes connecting or hooking to the game process 427. These connections exist because MAGIC always runs concurrently with the game and the operating system, unless it is turned off. If the gamer wants to change the profile settings 410, he can first edit his game profile as previously described. Then the database of profile settings is refreshed 415, and MAGIC is connected to the complete touchscreen-OS-MAGIC-game system 420. For MAGIC to function properly it must always be running. This is reflected in loop 480 in the bottom right-hand corner of FIG. 4b. Loop 480 is part of the game process and includes message box 460, and an analytical scheme with boxes 474, 476, and 468 checking to see if the game is running and messages about game control are continuing to be sent.

Along with the game and OS startups, 407 and 405 respectively, the MAGIC Game Process also starts 408. First MAGIC initializes its database of game profile settings 417, and it hooks into the OS 420. MAGIC waits for a message that the application, i.e., the game, has started 470. Then it checks if the game profile is in the MAGIC database 424. If the game profile does exist in the database, MAGIC connects 427 to the game initialization process 475. At this point in the MAGIC game process, the OS, and the game process are all connected. If the decision box 424 determines the game profile does not exist, then it continues to wait for a system message 422. In other words, MAGIC simply runs in the background while the OS 402 and Game Process 401 run simultaneously.

The gesture parsing and translation functions from FIG. 3 are incorporated into FIGS. 4a and 4b. Event or step 450 represents a game player touching a multi-touch panel or screen. The touch gesture causes the input of touch data 452 into the operating system, which in turn causes the MAGIC game process to interact with the specific game and the OS. Gesture parser 455 creates a gesture message 457, which is dispatched or sent to message box 460. At this point two separate functions are occurring in the “Play Game” portion of MAGIC in FIG. 4. One function appears in the “Game Process” section 401 and the other in the MAGIC process. In the MAGIC section, game message 460 is received by MAGIC receiver 430 that checks if the message is a gesture 432. If it is a gesture message, it is translated from a gesture message to a Windows® message 434. If the translation is successful, it is sent to the Windows® OS for input as a keyboard or mouse gesture 440.

The described embodiments represent particular implementations of the present invention, which can actuate multi-touch panel gestures in computer applications and programs that do not natively support touch panel or touch screen gestures. Those of skill in the art will also understand the use of varying terms. For example, the context will show that the terms multi-touch panel and touch screen are often used as synonyms for the same type of input device. For the present invention there is no preferred size or functionality of the touch screen that is responsive to the movements of a user's fingers or hands. Although the invention has been described primarily in the context of its use in Windows®-based computer games, those of skill in the art will understand that modifications and variations to the invention can be made, as discussed in the preceding disclosures. For example, the previously noted uses in Google Earth and Chrome are certainly not game-specific applications. Likewise, MAGIC can be embodied in numerous ways. It can be made available by download, disc, thumb drive, external hard drive, and other types of electronic media that retain digital information. Alternatively, it can be incorporated into an existing operating system such as Windows®, as well Mac OS, Linux, and others. Similarly, those of skill in the art will appreciate that the present invention can be executed by a software application or a program that is hardwired to electronic media. Computer applications can be incorporated through a variety of hardware and software techniques. Therefore, the invention can be embodied as a method comprised of computer steps that generate an output on a viewing screen; as a device such as an application encoded on a CD or downloaded from the Internet onto computer memory or as a chip installed in a gaming computer; or, as a system. As those of skill in the art will understand, certain computer functions may require a particular sequence, while others may be sequenced in different ways. The advent of parallel processing presents a variety of ways of executing the steps to use the present invention.

Those of skill in the art will understand how to make and program a touch screen and how to make and program a computer to receive touch gestures and convert them to equivalent movements on a viewing screen. Likewise they understand how to convert the viewing screen motions into mouse clicks and keyboard strokes that create the same motion. Therefore, the term “means for receiving touch gestures from the touch screen and analyzing the touch gestures” should be construed as broadly as possible to represent any combination of programming, computer software, and computer hardware necessary to implement the claimed function. Likewise, the term “means, operably connected to the profile and the operating system, to cause the viewing screen to display the events” should be construed equally broadly for adaption to use with any size or type of computer, including small, specialized gaming computers. Although the preferred embodiment of MAGIC works with a single touch screen on which a user views the events or actions he wishes to create, MAGIC could also be used with a second viewing screen separate and apart from the touch screen. A touch screen and a viewing screen could be one and the same screen or they could be two or more separate screens. As technology improves, it is conceivable that the touch screen may become a virtual device that functions in three dimensions. For example, a user's hand could create three-dimensional or holographic events that would be perceived by fields of LEDs and sensors. In a similar vein, a glove could contain signaling or receiving devices that generate the three-dimensional movement. The motion picture industry uses versions of such movement tracking to create two-dimensional avatars on a motion picture screen.

Therefore, it is intended that the invention not be limited to the particular embodiments or uses described here, but that the invention will include all embodiments falling within the scope of the claims.

What is claimed is:

1. A method for implementing multi-touch gestures on a touchscreen for creating events in a computer application and operating system that do not natively support touch gestures, the method comprising the steps of:
entering a multi-touch gesture on a touch screen;
analyzing the nature of the multi-touch gesture;
determining whether the analyzed multi-touch gesture corresponds to one of a list of non-multi-touch gestures in an application profile; and,
sending a message to at least one of the computer application and the operating system to create an event on the touch screen by executing the non-multi-touch gesture that corresponds to the multi-touch gesture on the touch screen.

2. The method of claim 1, wherein the computer application is a game.

3. The method of claim 1, wherein the list of non-multi-touch gestures includes at least one of a tap, a drag, a zoom, a rotate, and a two-finger tap.

4. The method of claim 3, wherein a user has the option of specifying a correspondence between a multi-touch gesture and a non-multi-touch gesture.

5. The method of claim 4, wherein the user can determine not to actuate a non-multi-touch gesture that corresponds to a multi-touch gesture.

6. A system for using a touch screen to control a user's viewing screen that is controlled by a computer application and by an operating system that is adapted to change the screen view in response to actuations of a keyboard or a mouse, comprising:
a touch screen responsive to multi-touch gestures;
electronic media containing an operating system and a computer application, wherein at least one of the computer application and the operating system are programmed to actuate non-multi-touch gestures on the viewing screen;
means for receiving touch gestures from the touch screen and analyzing the gestures;
a profile of user-selectable viewing screen controls including at least one of a tap, a drag, a zoom, a rotate, and a two-finger tap, wherein the operating system is programmed to cause the viewing screen to display events caused by the controls;
means, operably connected to the profile and the operating system, to cause the viewing screen to display the events.

7. The system of claim 6, wherein the touch screen and the viewing screen are the same screen.

8. The system of claim 6, wherein the touch screen and the viewing screen are different screens.

9. The system of claim 6, wherein a user can choose to implement none of the profile's controls.

10. An application for use with an electronic game that is controlled by a touch screen and in which the electronic game contains programming natively adapted to respond to mouse clicks and keyboard strokes and whose programming is not natively responsive to game moves generated on a touch screen, comprising:
a computer readable medium with programming adapted to communicate with the electronic game and with an operating system on which the electronic game is running;
means, on computer readable medium, for receiving signals representing a touch gesture on the touch screen;
means, on computer readable medium, for converting touch gesture signals from the touch screen to mouse and keystroke signals adapted to create an event on a viewing screen;
a user-selectable game profile, displayable on a viewing screen and stored on a computer readable medium, for entering into the application a game choice and a user's choices for the correspondence between touch screen gestures and preprogrammed mouse and keystroke signals; and,
means for transmitting a gesture signal to at least one of the game and the operating system for generating a game move that appears on the viewing screen.

11. The application of claim 10, further comprising a profile in which a touch gesture on the touch screen can result in no game move appearing on the viewing screen.

12. The application of claim 10, wherein the touch screen gestures include at least one of a tap, a drag, a zoom, a rotate, or a two-finger tap.

13. The application of claim 10, further comprising programming to provide at least one alternate correspondence between touch gestures and gestures programmed into at least one of the game and the operating system.
